(19) United States
(12) Patent Application Publication
(10) Pub. No.: US 2006/0248781 A1
(43) Pub. Date: Nov. 9, 2006

(54) Float, method for attaching the same to a line and method for using the same

(76) Inventor: Daniel Horvath, Marseilles, IL (US)

Correspondence Address: PATENTS+TMS;A Professional Corporation, 1914 North Milwaukee Avenue, Chicago, IL, 60647, US

(21) Appl. No.: 11/124,741

(22) Filed: May 9, 2005

(51) Int. Cl. A01K 93/00

(52) U.S. Cl. 43/44.92; 43/44.95

(57) ABSTRACT

A float attaches to a line to be used with a rod to fish. A first end of the float has a slot for attaching the float to the line. The first end and the slot of the float have a pliable substance. The slot may be filled and/or may be covered with the pliable substance which may be cured. The line inserts into the slot to remove a first portion of the pliable substance from the slot. A second portion of the pliable substance remains in the slot and/or causes a friction on the line in the slot. The friction of the pliable substance holds and/or retains the line within the slot of the float. The float is attached to the line in the slot by the second portion of the pliable substance. The slot and the pliable substance allow the float to move along the line while the float is attached to the line.

### BACKGROUND OF THE INVENTION

The present invention generally relates to a float, a method for attaching the same to a line and a method for using the same. More specifically, the present invention relates to a float, a method for attaching the float to a fishing line and a method for using the float on the fishing line with, for example, a fishing rod. An end of the float may have a slot thereon for attaching the float to the line. The first end of the float may be covered with, for example, a pliable substance. As a result, the slot may be filled with and/or may be covered by the pliable substance. The pliable substance may be cured and/or may harden. The line may cut into and/or may be inserted into the slot. As a result, a first portion of the pliable substance within the slot may be removed from the slot by the line. A second portion of the pliable substance may remain in the slot and/or may cause a friction on and/or may retain the line within the slot. As a result, the float may be attached to the line with the slot and/or the second portion of the pliable substance within the slot.

It is generally known, for example, that a user, such as, for example, a fisherman may use, for example, a fishing rod, a fishing reel, a line, a hook, a sinker, a float and/or a bobber during fishing to catch an aquatic animal, namely, a fish. The fishing rod may have a handle end and a tip end which is opposite to the handle end. The fishing reel is attached to the fishing rod and is adjacent to the handle end. A first end of the line may be attached to the reel, and a second end of the line may extend along a length of the fishing rod. The hook and/or the sinker may be attached to the line and/or may be adjacent to the second end of the line. Live bait, such as, for example, earthworms, crickets, snails, minnows may be attached to the hook. Alternatively, an artificial lure, such as, for example, a jig may be attached to the line and may be used instead of the hook and/or the sinker.

The bobber or the float may have a spring-loaded clip extending therefrom. The user may compress the spring-loaded clip and may insert the line between the clip and an external surface of the bobber or the float. The user may release the spring-loaded clip which may apply a force inwardly with respect to the bobber or the float. As a result, the bobber or the float may be attached to the line at a first position between the tip end of the fishing rod and the artificial lure, the hook or the sinker. However, the force of the spring-loaded clip against the line may damage, may weaken and/or may fray the line at the first position. Alternatively, the force of the spring-loaded clip may break the line at the first line. The bobber or the float may be made from a material, such as, for example, foam, cork and/or the like. As a result, the bobber may be buoyant and/or may float in, for example, water.

The user may cast the hook, the sinker, the artificial lure, the bobber, the float and/or the second end of the line in a body of water, such as, for example, a lake, a pond, a river, a stream, an ocean and/or the like. The sinker, the hook or the artificial lure may pull the second end of the line downward towards a bottom surface of the water. The bobber or the float may pull the hook, the sinker, the live bait or the artificial lure in a direction towards a top surface of the water. The bobber or the float may float on the top surface of the water. As a result, the hook, the sinker, the live bait or the artificial lure may be suspended at a first depth between the bottom surface and the top surface of the water.

The user may compress the spring-loaded clip of the bobber and may move the bobber or the float inward or outward with respect to the second end of the line to a second position on the line. The user may release the spring-loaded clip, and the bobber or the float may be attached to the line at the second position on the line. However, the spring-loaded clip of the bobber or the float damages, weakens, frays and/or breaks the line at the second position. The hook, the sinker, the live bait or the artificial lure may be moved upward or downward, respectively, to a second depth between the bottom surface and the top surface of the body of water based on the second position of the bobber or the float. As a result, the user may position the hook, the sinker, the live bait or the artificial lure in the water by moving the bobber or the float along the line.

An aquatic animal, such as, for example, a fish, may be attracted to the live bait or the artificial lure on the second end of the line. The aquatic animal may bite or may attempt to digest the live bait or the artificial lure. The hook or the artificial lure may pierce a mouth and/or a body of the aquatic animal. As a result, the mouth and/or the body of the aquatic animal may be attached to the hook or the artificial lure on the line. The aquatic animal may attempt to free itself from the hook or the artificial lure. As a result, the bobber or the float which may be floating on the top surface of the water may move along the top surface of the water and/or may be pulled under the top surface of the water by the aquatic animal.

The bobber or the float may indicate to the user that the aquatic animal may be attached to the hook or the artificial lure on the line. The user may begin to reel in the aquatic animal with the fishing reel attached to the fishing rod. As the user is reeling the aquatic animal inward towards the tip end of the fishing rod, the bobber or the float on the line may abut the tip end of the rod. The spring-loaded clip of the bobber or the float prevents the line from sliding inward or outward with respect to the bobber. The user is impeded from reeling the second end of the line and/or the aquatic animal inward with respect to the tip end of the fishing rod by the bobber. As a result, the aquatic animal remains in the water and/or may free itself from the hook or the artificial lure.

A need, therefore, exists for a float, a method for attaching the same to a line, and a method for using the same which may allow for simplified attachment of the float to the line. Further, a need exists for a float, a method for attaching the same to a line, and a method for using the same which may not damage, may not fray, may not weaken and/or may not break the line during attachment of the float to the line. Moreover, a need exists for a float, a method for attaching the same to a line, and a method for using the same which may provide a slot and/or a pliable substance therein for attachment of the float to the line. Furthermore, a need exists for a float, a method for attaching the same to a line, and a method for using the same which may allow the float to be moved along the line without damaging, fraying, weakening or breaking the line.

### SUMMARY OF THE INVENTION

The present invention generally relates to a float, a method for attaching the float to a fishing line and a method for using the float on the fishing line with a fishing rod. A first end of the float may be covered with, for example, a slow-curing, pliable substance. As a result, a slot may be filled with and/or plugged with the slow-curing, pliable substance. The slow-curing, pliable substance may be cured to stiffen and/or to harden the pliable substance. The line may be inserted into the slot and/or may cut a first portion of the pliable substance. As a result, a first portion of the pliable substance in the slot may be removed from the slot by the line. A second portion of the pliable substance may remain within the slot. The line may be held within the slot by the second portion of the pliable substance. As a result, the float may be attached to the line and/or the slot, and the second portion of the pliable substance may hold and/or may retain the line therein.

To this end, in an embodiment of the present invention, a float that attaches to a line wherein the float and the line are used to fish for an aquatic animal at a depth in a body of water wherein an end of the line is attachable to the aquatic animal is provided. The float has a body having an end wherein the body is buoyant wherein the body is defined by an exterior surface and further wherein the body maintains the end of the line at the depth in the body of water. Further, the float has a slot at the end of the body wherein the slot extends inward with respect to the exterior surface of the body. Moreover, the float has a pliable substance applied to the end of the body wherein the pliable substance fills the slot wherein the line inserts into the pliable substance and further wherein the pliable substance hardens to attach the body to the line.

In an embodiment, the slot is an L-shaped groove.

In an embodiment, the pliable substance is a silicone-based glue.

In an embodiment, the body is made from plastic, wood or cork.

In an embodiment, the body is circular.

In an embodiment, the body is oblong-shaped.

In an embodiment, the body has a length between seven-eighths of an inch to seven inches.

In another embodiment of the present invention, a method for attaching a float to a line of a rod wherein an end of the line extends outward with respect to the rod wherein the line and the rod are used to fish for an aquatic animal in a body of water is provided. The method has the step of providing a float having a body and an end extending outward with respect to the body wherein the end has a slot and further wherein the float is buoyant in the body of water. Further, the method has the steps of inserting a pliable substance into the slot and inserting the line of the rod into the slot. Moreover, the method has the step of securing the float at a first position on the line with the pliable substance wherein the pliable substance allows the float to move along the line between the end of the rod and the end of the line.

In an embodiment, the method has the step of applying the pliable substance to the end of the float.

In an embodiment, the method has the step of penetrating the pliable substance with the line.

In an embodiment, the method has the step of curing the pliable substance.

In an embodiment, the method has the step of removing a portion of the pliable substance.

In an embodiment, the pliable substance is a silicone-based glue.

In an embodiment, the method has the step of cutting the slot into the end of the float.

In another embodiment of the present invention, a method for using a float with a line and a rod to fish for an aquatic animal at a first depth or a second depth in a body of water wherein an end of the line extends outward with respect to the rod is provided. The method has the step of attaching a float to the line wherein the float is defined by an exterior surface wherein the float has a slot extending inward with respect to the exterior surface of the float wherein a pliable substance is inserted into the slot of the float wherein the line extends through the slot of the float and further wherein the pliable substance is hardened to secure the line within the slot of the float and further wherein the float is buoyant. Further, the method has the step of positioning the float at a first position on the line wherein the pliable substance holds the float at the first position on the line. Moreover, the method has the step of inserting the float and the end of the line into the body of water wherein the float maintains the end of the line at the first depth in the body of water or at the second depth in the body of water.

In an embodiment, the pliable substance is a silicone-base glue.

In an embodiment, the method has the step of moving the float a second position on the line to maintain the end of the line at the second depth in the body of water.

In an embodiment, the method has the step of maintaining the float at the second position on the line with the pliable substance.

In an embodiment, the method has the step of reeling the end of the line inward with respect to the float.

In an embodiment, the method has the step of reeling the aquatic animal at the end of the line inward with respect to the rod.

It is, therefore, an advantage of the present invention to provide a float, a method for attaching the same to a line and a method for using the same which may provide a slot or a groove for attaching the float to the line.

Another advantage of the present invention is to provide a float, a method for attaching the same to a line and a method for using the same which may provide a slow-curing, pliable substance for attaching the float to the line.

And, another advantage of the present invention is to provide a float, a method for attaching the same to a line and a method for using the same which may prevent the line from being damaged, frayed, weakened and/or broken during attachment of the float to the line.

Yet another advantage of the present invention is to provide a float, a method for attaching the same to a line and a method for using the same which may allow simplified attachment of the float to the line.

A further advantage of the present invention is to provide a float, a method for attaching the same to a line and a method for using the same which may allow the line to cut a portion of a pliable substance within a slot of the float for attachment.

Moreover, an advantage of the present invention is to provide a float, a method for attaching the same to a line and a method for using the same which may provide a friction on the line from a pliable substance within a slot of the float for attachment of the float to the line.

And, another advantage of the present invention is to provide a float, a method for attaching the same to a line and a method for using the same which may provide a slot or a groove for sliding the float along the line.

Yet another advantage of the present invention is to provide a float, a method for attaching the same to a line and a method for using the same which may be utilized as a fishing bobber while fishing in a body of water.

Another advantage of the present invention is to provide a float, a method for attaching the same to a line and a method for using the same which may allow a depth of a hook, a sinker, live bait and/or an artificial lure in a body of water to be adjusted by moving the float along the line.

Yet another advantage of the present invention is to provide a float, a method for attaching the same to a line and a method for using the same which may allow an end of the line to be reeled inward with respect to a tip of a fishing rod and the float while the float abuts the tip of the fishing rod and the line passes through a slot of the float.

A still further advantage of the present invention is to provide a float, a method for attaching the same to a line and a method for using the same which may allow the line to be retained within a slot of the float by a pliable substance.

Additional features and advantages of the present invention are described in, and will be apparent from, the detailed description of the presently preferred embodiments and from the drawings.

### BRIEF DESCRIPTION OF THE DRAWINGS

FIG. 1 is a perspective view of a float attached to a line in an embodiment of the present invention.

FIG. 2 is a front plan view of the float and the line of FIG. 1 attached to a fishing rod, shown in perspective, in an embodiment of the present invention.

FIG. 3 is a perspective view of a float attached to a line in another embodiment of the present invention.

FIG. 4 is a cross-sectional view of a slot of the float in FIGS. 1 and 2 as taken along line IV-IV in an embodiment of the present invention.

FIG. 5 is a cross-sectional view of a slot of the float in FIG. 3 as taken along line V-V in an embodiment of the present invention.

### DETAILED DESCRIPTION OF THE PREFERRED EMBODIMENTS

The present invention generally relates to a float, a method for attaching the same to a line and a method for using the same. More specifically, the present invention relates to a float, a method of attaching the float to a fishing line and a method for using the float on the fishing line with a fishing rod. A first end of the float may be covered with, for example, a pliable substance. As a result, a slot may be filled with and/or may be covered by the pliable substance. The pliable substance may be cured to be harden and/or to be stiffened. The line may cut into and/or may be inserted into the slot. As a result, a first portion of the pliable substance may be removed from the slot by the line. A second portion of the pliable substance may remain in the slot and/or may cause a friction on the line within the slot. As a result, the float may be attached to the line in the slot by the second portion of the pliable substance.

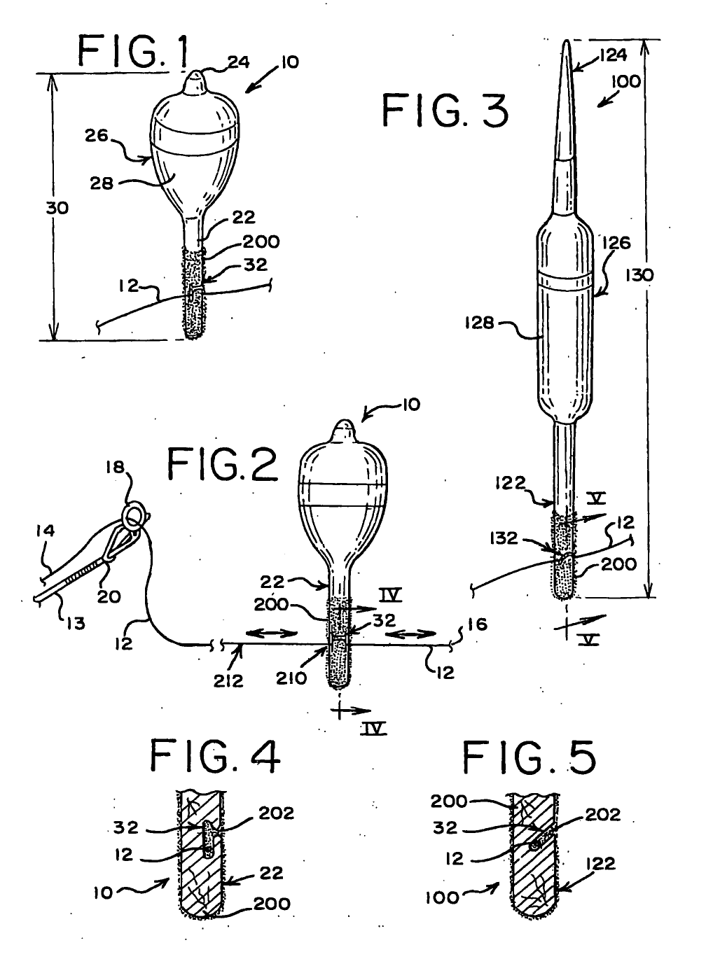

Referring now to the drawings wherein like numerals refer to like parts, FIGS. 1, 2 and 4 illustrate a float 10 attached to a line 12 in an embodiment of the present invention. The line 12 may be, for example, a fishing line, such as, for example, a six-pound test line, an eight-pound test line, a twelve-pound test line and/or the like. The line 12 may be attached to a fishing reel (not shown in the drawings) and/or a fishing rod 13 as illustrated in FIG. 2. The line 12 may have a first end 14 and/or a second end 16 which is opposite to the first end 14. The line 12 may extend through an eyelet 18 at a tip end 20 of the fishing rod 13. The first end 14 of the line 12 may be adjacent to the fishing rod 13, to the eyelet 18 and/or the tip end 20 of the fishing rod 13. The second end 16 of the line 12 may extend outward with respect to the tip end 20 of the fishing rod 13. Fishing tackle (not shown in the drawings), such as, for example, a hook, a sinker, live bait and/or an artificial lure may be attached to the second end 16 of the line 13.

The float 10 may have a first end 22, a second end 24 and/or a body 26 which may connect the first end 22 and the second end 24. The first end 22 and/or the second end 24 may extend outward with respect to the body 26 of the float 10. The float 10 may have an exterior surface 28 and a length 30. The float 10 may be, for example, a fishing bobber. The length 30 of the float 10 may be between, for example, seven-eighths of an inch to three inches. The float 10 may have a shape, such as, for example, a pear shape, a round shape, a oval shape, and/or the like. The float 10 may be made from a material, such as, for example, cork, wood, foam and/or plastic. As a result, the float 10 may be buoyant and/or may float in, for example, a body of water (not shown in the drawings). The present invention should not be deemed as limited to the embodiments of a specific length, a specific shape and/or a specific material of the float 10.

The exterior surface 28 at the first end 22 of the float 10 may have a groove 32 thereon as illustrated in FIGS. 1, 2 and 4. The groove 32 may extend inward with respect to the exterior surface 28 of the float 10. The groove 32 may be cut or may be carved into the first end 22 of the float 10. The line 12 may be insertable into the groove 32 of the float 10. As illustrated in FIG. 4, the groove 32 may be, for example, L-shaped and/or the like. The present invention should not be deemed as limited to the embodiments of a specific shape of the groove 32. It should be understood that the groove 32 may be cut into the float 10 with any method or any means which may be generally known and/or may be implemented by one having ordinary skill in the art.

FIGS. 3 and 5 illustrate a float 100 attached to the line 12 in another embodiment of the present invention. The float 100 may be attached to the fishing rod 13. The float 10 may have a first end 122, a second end 124 and/or a body 126 which may connect the first end 122 to the second end 124. The first end 122 and/or the second end 124 may extend outward with respect to the body 126 of the float 100. The float 100 may have an exterior surface 128 and/or a length 130. The float 100 may be, for example, a fishing bobber. The length 130 of the float 100 may be between, for example, two inches to seven inches. The float 100 may have a shape, such as, for example, a torpedo shape, a pencil shape, an oblong shape and/or the like. The float 100 may be made from a material, such as, for example, cork, wood, foam and plastic. As a result, the float 100 may be buoyant and/or may float in, for example, the body of water. The present invention should not be deemed as limited to the embodiments of a specific length, a specific shape and/or a specific material of the float 100.

The exterior surface 128 at the first end 122 of the float 100 may have a slot 132 as illustrated in FIGS. 3 and 5. The slot 132 may extend inward with respect to the exterior surface 128 of the float 100. The slot 132 may be cut into or may be carved into the first end 122 of the float 100. The line 12 may be insertable into the slot 132 of the float 100. It should be understood that the slot 132 may be cut into the float 100 with any method or means which may be generally known and/or may be implemented by one having ordinary skill in the art.

The first end 22 of the float 10 as shown in FIGS. 1, 2 and 4 and/or the first end 122 of the float 100 as shown in FIGS. 3 and may be covered with a pliable substance 200. The pliable substance 200 may be, for example, a silicone-based glue. The pliable substance 200 may be applied to the floats 10, 100 by a method, such as, for example, brushing the pliable substance 200 onto the floats 10, 100, spraying the pliable substance 200 onto the floats 10, 100, or dipping the floats 10, 100 into the pliable substance 200. As a result, the groove 32 of the float 10 and/or the slot 132 of the float 100 may be covered and/or may be filled by the pliable substance 200. The present invention should not be deemed as limited to the embodiments of a specific technique for applying the pliable substance 200 to the floats 10, 100.

The pliable substance 200 in the groove 32 and/or the slot 132 of the float 10 and/or the float 100, respectively, may be cured. As a result, the pliable substance 200 may harden within the groove 32 and/or the slot 132 and/or may have a stiffness. A user (not shown in the drawings) may push, may force and/or may insert the line 12 into the groove 32 or the slot 132 of the float 10 or the float 100, respectively. The line 12 may cut into the pliable substance 200 within the groove 32 or the slot 132. As a result, the line 12 may dislodge, may remove and/or may separate a removable portion (not shown in the drawings) of the pliable substance 200 from the groove 32 and/or the slot 132. The present invention should not be deemed as limited to the embodiments of a specific cure time of the float pliable substance 200. It should be understood that the pliable substance 200 may be cured by any curing technique which may be generally know and/or may be implemented by one having ordinary skill in the art.

The line 12 in the groove 32 or the slot 132 may not remove an attachable portion 202 of the pliable substance 200 within the groove 32 or the slot 132. The attachable portion 202 of the pliable substance 200 may remain attached to the groove 32 and/or the slot 132 of the float 10 and/or the float 100, respectively. The attachable portion 202 may remain with the line 12 within the groove 32 and/or the slot 132 of the float 10 and/or the float 100, respectively. The line 12 may be held within the attachable portion 202 of the pliable substance 200 in the groove 32 and/or the slot 132 as illustrated in FIGS. 4 and 5. As a result, the line 12 may be held within, may be retained within and/or may be secured within the groove 32 and/or the slot 132 by the attachable portion 202 of the pliable substance 200. The float 10 and/or the float 100 may be attached to the line 12 via the attachable portion 202 of the pliable substance 200 within the groove 32 and/or the slot 132, respectively.

The attachable portion 202 of the pliable substance 200 may prevent damage to, fraying of, weakening of and/or breaking of the line 12 while the float 10 or the float 100 may be attached to the line 12. The stiffness of the attachable portion 202 of the pliable substance 200 may prevent the line 12 from slipping out of, from falling out of and/or from dislodging from the groove 32 and/or the slot 132 of the floats 10, 100, respectively. Moreover, the stiffness of the attachable portion 202 of the pliable substance 200 may not restrict the floats 10, 100 from moving along the line 12 as illustrated in FIG. 2. However, the stiffness of the attachable portion 202 of the pliable substance 200 may prevent the floats 10, 100 from detaching from the line 12 while moving along the line 12. As a result, the floats 10, 100 may be moved inward or outward with respect to the second end 16 of the line 12 while the floats 10, 100 remain attached to the line 12.

As set forth above and illustrated in FIGS. 1, 2 and 4, the user may attach the float 10 to the line 12 of the fishing rod 13. The user may move and/or may set the float 10 along the line 12 to a first position 210 on the line 12. The first position 210 on the line 12 may be located between the eyelet 18 of the fishing rod 13 and the second end 16 of the line 12. The stiffness of the attachable portion 202 of the pliable surface 200 in the groove 32 of the float 10 may maintain, may retain and/or may hold the float 10 at the first position 210 on the line 12. The user may cast the second end 16 of the line 12, the float 10 and/or the fishing tackle into the body of water. The body of water may be, for example, a lake, a pond, a river, a stream, an ocean and/or the like. The fishing tackle may pull the second end 16 of the line 12 inward with respect to a bottom of the body of water.

A buoyancy of the float 10 may pull and/or may raise the fishing tackle and/or the second end 16 of the line inwards with respect to a top surface of the body of the water. The buoyancy of the float 10 may raise the float 10 in the body of water until the float 10 extends outward with respect to the top surface of the water. The float 10 may prevent the fishing tackle and/or the second end 16 of the line 12 from contacting the bottom surface of the body of water. As a result, the fishing tackle and/or the second end 16 of the line 12 may be suspended and/or may be maintained in the body of water at a first depth between the bottom surface and the top surface of the body of water. The first depth in the body of water may be based on the first position 210 of the float 10 on the line 12. Furthermore, an aquatic animal (not shown in the drawings) may be at the first depth in the body of water.

The user may move the float 10 to a second position 212 on the line 12. The user may move and/or may position the float 10 at the second position 212 on the line 12 without detaching the float 10 from the line 12. As set forth above, the stiffness of the attachable portion 202 of the pliable substance 200 in the groove 32 of the float 10 may prevent the float 10 from detaching from the line 12 while being moved along the line 12. Furthermore, the stiffness of the attachable portion 202 of the pliable substance 200 may maintain, may retain and/or may hold the float 10 at the second position 212 on the line 12. Moreover, the pliable substance 200 may not damage, may not fray, may not weaken and/or may not break the line 12 as the float 10 moves from the first position 210 to the second position 212 on the line 12.

The user may cast the float 10, the fishing tackle and/or the second end 16 of the line 12 into the body of water with the fishing rod 13. The float 10 at the second position 212 on the line 12 may suspend and/or may maintain the fishing tackle and/or the second end 16 of the line 12 at a second depth between the bottom surface and the top surface of the body of water. The second depth in the body of water may be based on the second position 212 of the float 10 on the line 12. The aquatic animal may be at the second depth in the body of water. As a result, the user may position and/or may suspend the fishing tackle and/or the second end 16 of the line 12 at the first depth or the second depth to fish for the aquatic animal.

The aquatic animal may be, for example, a fish, an eel, a snake, a shrimp, a lobster, a frog, a clam, a squid, a turtle and/or the like. The aquatic animal may be attracted to the fishing tackle adjacent to the second end 16 on the line 12 of the fishing rod 13. The aquatic animal may bite or may attempt to digest the fishing tackle suspended in the body of water at the first depth or the second depth, respectively. The fishing tackle may pierce a mouth and/or a body of the aquatic animal. As a result, the mouth and/or the body of the aquatic animal may be attached to and/or may be hooked by the fishing tackle adjacent to the second end 16 of the line 12. The aquatic animal may swim to free itself, to unhook itself and/or to detach itself from the fishing tackle on the line 12. As a result, the float 10 on the top surface of the body of water may move along the top surface of the water in a path corresponding to a path swam by the aquatic animal. The path of the aquatic animal may cause the float 10 to be pulled below the top surface of the body of water. The present invention should not be deemed as limited to the embodiments of a specific aquatic animal.

The path of the float 10 may indicate to the user that the aquatic animal may be attached to and/or hooked to the fishing tackle and/or the second end 16 of the line 12. The user may begin to reel in the aquatic animal, the fishing tackle and/or the second end 16 of the line 12. As the user reels the second end 16 of the line 12, the float 10 may be pulled inward with respect to the eyelet 18 of the fishing rod 13. As a result, the float 10 may abut the eyelet 18 of the fishing rod 13 before the aquatic animal, the fishing tackle and/or the second end 16 of the line are pulled from the body of water.

The attachable portion 202 of the pliable substance 200 in the groove 32 of the float 10 may allow the line to slide and/or to move through the groove 32 inward with respect to the eyelet 18. As a result, the second end 16 of the line 12 may be reeled inward with respect to the float 10. The stiffness of the attachable portion 202 of the pliable substance 200 in the groove 32 may prevent the float from detaching from and/or from slipping off of the line 12. The attachable portion 202 of the pliable substance 200 in the groove 32 may not damage, may not fray, may not weaken and/or may not break the line 12 as the line 12 moves through the groove 32 of the float 10. As a result, the user may reel and/or may remove the aquatic animal, the fishing tackle and/or the second end 16 of the line 12 from the body of water as the float 10 remains attached to the line 12 and abutted to the eyelet 18 of the fishing rod 13. The user may remove the first aquatic animal or the second aquatic animal from the fishing tackle and/or may cast the float 10, the fishing tackle and/or the second end 16 of the line 12 into the body of water with the fishing rod 13.

It should be understood that various changes and modifications to the presently preferred embodiments described herein will be apparent to those skilled in the art. Such changes and modifications may be made without departing from the spirit and scope of the present invention and without diminishing its attendant advantages. It is, therefore, intended that such changes and modifications be covered by the appended claims.

I claim:

1. A float that attaches to a line wherein the float and the line are used to fish for an aquatic animal at a depth in a body of water wherein an end of the line is attachable to the aquatic animal, the float comprising:
a body having an end wherein the body is buoyant wherein the body is defined by an exterior surface and further wherein the body maintains the end of the line at the depth in the body of water;
a slot at the end of the body wherein the slot extends inward with respect to the exterior surface of the body; and
a pliable substance applied to the end of the body wherein the pliable substance fills the slot wherein the line inserts into the pliable substance and further wherein the pliable substance hardens to attach the body to the line.

2. The float of claim 1 wherein the slot is an L-shaped groove.

3. The float of claim 1 wherein the pliable substance is a silicone-based glue.

4. The apparatus of claim 1 wherein the body is made from plastic, wood or cork.

5. The apparatus of claim 1 wherein the body is circular.

6. The apparatus of claim 1 wherein the body is oblong-shaped.

7. The apparatus of claim 1 wherein the body has a length between seven-eighths of an inch to seven inches.

8. A method for attaching a float to a line of a rod wherein an end of the line extends outward with respect to the rod wherein the line and the rod are used to fish for an aquatic animal in a body of water, the method comprising the steps of:
providing a float having a body and an end extending outward with respect to the body wherein the end has a slot and further wherein the float is buoyant in the body of water;
inserting a pliable substance into the slot;
inserting the line of the rod into the slot; and
securing the float at a first position on the line with the pliable substance wherein the pliable substance allows the float to move along the line between the end of the rod and the end of the line.

9. The method of claim 8 further comprising the step of:
applying the pliable substance to the end of the float.

10. The method of claim 8 further comprising the step of:
penetrating the pliable substance with the line.

11. The method of claim 8 further comprising the step of:
curing the pliable substance.

12. The method of claim 8 further comprising the step of:
removing a portion of the pliable substance.

13. The method of claim 8 wherein the pliable substance is a silicone-based glue.

14. The method of claim 8 further comprising the step of:
cutting the slot into the end of the float.

15. A method for using a float with a line and a rod to fish for an aquatic animal at a first depth or a second depth in a body of water wherein an end of the line extends outward with respect to the rod, the method comprising the steps of:
attaching a float to the line wherein the float is defined by an exterior surface wherein the float has a slot extending inward with respect to the exterior surface of the float wherein a pliable substance is inserted into the slot of the float wherein the line extends through the slot of the float and further wherein the pliable substance is hardened to secure the line within the slot of the float and further wherein the float is buoyant;
positioning the float at a first position on the line wherein the pliable substance holds the float at the first position on the line; and
inserting the float and the end of the line into the body of water wherein the float maintains the end of the line at the first depth in the body of water or at the second depth in the body of water.

16. The method of claim 15 wherein the pliable substance is a silicone-base glue.

17. The method of claim 15 further comprising the step of:
moving the float a second position on the line to maintain the end of the line at the second depth in the body of water.

18. The method of claim 15 further comprising the step of:
maintaining the float at the second position on the line with the pliable substance.

19. The method of claim 15 further comprising the step of:
reeling the end of the line inward with respect to the float.

20. The method of claim 15 further comprising the step of:
reeling the aquatic animal at the end of the line inward with respect to the rod.
